(19) United States
(12) Patent Application Publication
(10) Pub. No.: US 2016/0064142 A1
(43) Pub. Date: Mar. 3, 2016

(54) TRANSFORMER WITH INTEGRATED FLUID FLOW SENSOR

(71) Applicant: RoMan Manufacturing, Inc., Grand Rapids, MI (US)

(72) Inventors: Donald B. DeCorte, Hudsonville, MI (US); Mark B. Siehling, Walker, MI (US)

(21) Appl. No.: 14/468,483

(22) Filed: Aug. 26, 2014

(51) Int. Cl. H01F 27/40; H01F 27/28; H01F 27/10; G01F 1/32; H01F 27/24

(52) U.S. Cl. CPC H01F 27/402; G01F 1/3209; H01F 27/24; H01F 27/10; H01F 27/2823; H01F 27/2876; H01F 2027/404; H01F 2027/406; H01F 2027/408

(57) ABSTRACT

A fluid-cooled transformer includes a primary winding, a secondary winding, a fluid flow path, and a flow sensor that is both operatively coupled to the fluid flow path and protectively positioned within the transformer.

### BACKGROUND OF THE INVENTION

The present invention relates to electrical transformers, and more particularly to fluid-cooled, high-power transformers suitable for example for resistance welding.

High-power electrical transformers are commonly used in resistance welding, for example, by inclusion in a transgun. “Transgun” is a term commonly used in the resistance welding industry to refer to a welding gun and transformer that are closely coupled together on a common mounting bracket. The transgun can either be used in a manual operation via a hanger or can be mounted directly on the end of an industrial robot for use in welding automation.

The transformer typically produces a large amount of heat during operation and must be cooled in order to prevent overheating and possible destruction of the transformer. One well-known means for cooling a transformer is to provide a cooling system through which liquid coolant is circulated to convey heat away from the transformer. The cooling systems typically include 1) a water-flow sensor responsive to the coolant flow and 2) a control responsive to the sensor for monitoring the flow of coolant through the cooling system. If the control detects a problem, for example indicating a leak or blockage, within the cooling system, the control can provide a prompt or other signal indicating that the transformer should be shut down to avoid damage.

The inclusion of a flow sensor, although highly beneficial, creates a number of issues. First, a significant length of tubing or hoses is required to convey the coolant from the transformer to the sensor and vice versa. This tubing is expensive and provides opportunities for failure. Second, a housing is required to protect the relatively sensitive flow sensor within the manufacturing environment. When the sensor housing is mounted on a robotic arm, the housing adds undesirable weight, thereby reducing the speed at which the gun is able to operate.

### SUMMARY OF THE INVENTION

The noted issues are addressed by the present invention comprising a fluid-cooled transformer including a primary, a secondary, a fluid flow path through at least one of the primary and the secondary, and a flow sensor operatively coupled to the fluid flow path and protectively positioned within the transformer.

In a disclosed embodiment, the fluid-cooled transformer includes a secondary winding having two terminals. The secondary winding and terminals define a cooling circuit having a fluid inlet and a fluid outlet, and the cooling circuit is configured to carry fluid for cooling the transformer. A fluid flow meter is located within the transformer and is responsive to a flow of fluid circulated within the cooling circuit.

The present transformer provides a reduction in complexity, weight, cost, and assembly/manufacture time, while also providing improved reliability of the transformer and overall system. The weight of the transformer and sensor is reduced by eliminating the necessity of a sensor housing, external mounting brackets for the housing, external hoses, and the associated fittings.

These and other features and advantages of the invention will be more fully understood and appreciated by reference to the entire application including the specification, the claims, and the drawings.

### BRIEF DESCRIPTION OF THE DRAWINGS

FIG. 1 is an isometric view of a secondary winding and integrated fluid flow sensor of a transformer, according to one embodiment;

FIG. 2 is a partially exploded view of FIG. 1, illustrating the sensor in an exploded position;

FIG. 3 is a schematic representation of the transformer of FIG. 1; and

FIG. 4 is an isometric view of a secondary winding and integrated fluid flow sensor of a transformer according to another embodiment.

### DESCRIPTION OF THE CURRENT EMBODIMENTS

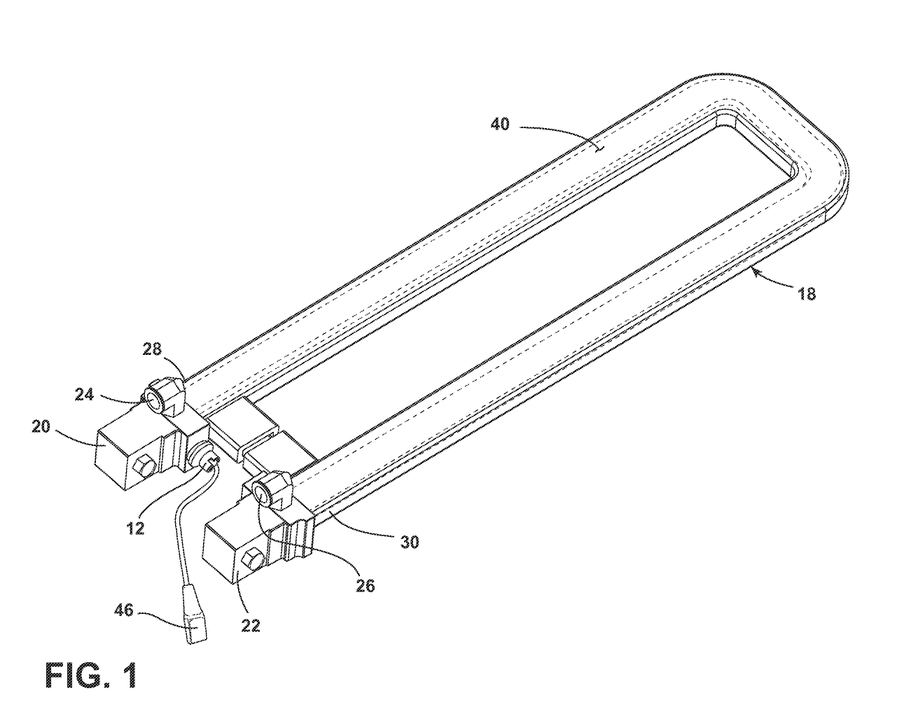

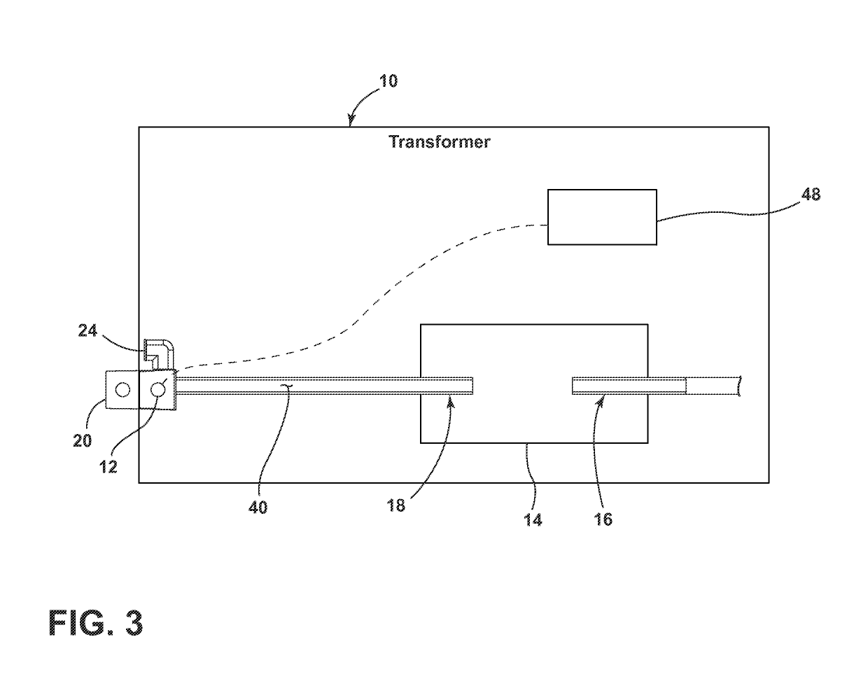

Referring to FIGS. 1-3, the numeral 10 generally designates an electrical transformer that includes an integrated fluid flow sensor 12. The transformer 10 includes a core 14, a primary winding 16, and a secondary winding 18. Further, the secondary winding 18 has an output terminal 20, an output terminal 22 of alternating polarity, a fluid outlet 24, and a fluid inlet 26. The core 14 and primary winding 16 are conventional, and the primary winding may include a plurality of coils electrically connected by suitable means.

The secondary winding 18 is a tubular, generally U-shaped member. In the illustrated example, the transformer 10 includes one secondary winding 18; however, as will be more fully described below, the transformer 10 may include a plurality of secondary windings. The secondary winding 18 has two ends 28 and 30 at which the output terminals 20 and 22 are secured. The output terminals 20 and 22 are joined with respective ends of the secondary winding 18. Further, the output terminals 20 and 22 include fluid couplings defining the fluid outlet 24 and fluid inlet 26, respectively.

To prevent overheating and damage to the transformer 10, a coolant, such as water, is circulated through the transformer 10. The secondary winding 18, output terminals 20 and 22, and fluid outlet and inlet 24 and 26 define a cooling circuit 40 that provides a passageway to circulate fluid throughout the transformer 10. A supply conduit can be secured to the fluid inlet 26 and a return conduit can be secured to the fluid outlet 24 to fluidly connect the cooling circuit 40 to a fluid supply/return. As fluid circulates through the cooling circuit 40, heat is drawn away from the primary and secondary windings 16 and 18, thereby cooling the transformer 10. The supply of coolant may be provided by a pump or any other conventional means. Alternately, the cooling circuit may be defined by the primary winding(s) instead of the secondary windings.

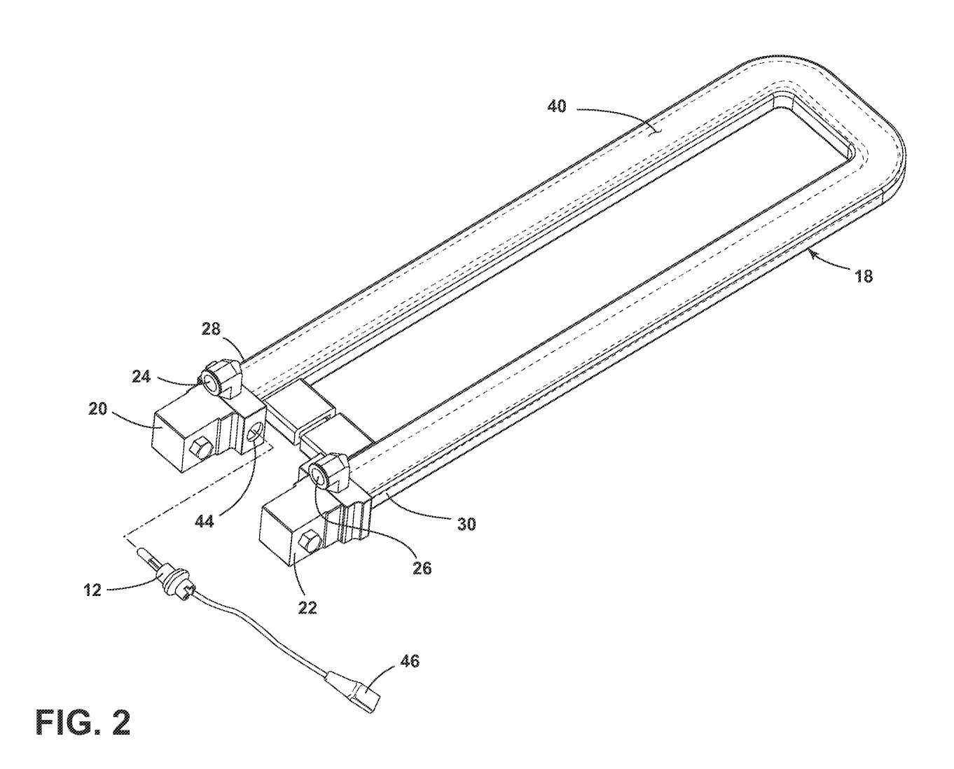

The flow of coolant circulated within the cooling circuit 40 is detected by the integrated flow sensor or fluid flow meter 12 to ensure that the transformer 10 operates within safe conditions. Referring to FIG. 2, the output terminal 20 includes a mounting hole 44 adapted to mount the flow meter 12 such that the flow meter 12 is operatively coupled with the cooling circuit 40. The flow meter 12 is protectively located within the transformer 10 and positioned in fluid communication with the fluid circulating in the cooling circuit 40. In the illustrated example, the flow meter 12 is shown mounted to the output terminal 20; however, it should be understood that the flow meter 12 may alternatively be mounted to the alternate output terminal 22, or as will be discussed below, to other components that make up the cooling circuit.

The exemplary fluid flow meter 12 is a vortex shedding type flow meter, though other flow meters capable of detecting the flow of fluid could alternatively be used. The flow meter 12 includes an electrical connection 46 in electrical communication with a controller 48 external to the transformer 10. To protect the transformer 10 against overheating, the flow meter 12 is adapted to provide an indication to the controller 48 when fluid flow within the cooling circuit 40 is at a rate less than a predetermined fluid flow rate. If the rate of fluid flow falls below the predetermined threshold, the controller 48 can cause the transformer 10 to cease operating in response to the indication from the flow meter 12. For example, the controller 48 can terminate electrical power to the transformer 10. Optionally, the controller 48 may activate an alarm, send a signal, or otherwise indicate that there is an issue with the cooling circuit 40.

As used herein, the predetermined fluid flow rate is intended to mean an amount of coolant which is less than the minimum amount required to adequately cool the transformer during operation. Adequate cooling will vary depending on the specifics of the transformer itself and the application on which the transformer is being used. Inadequate coolant flow can result from a variety of causes; for example, failure of the coolant source or pump, obstruction in the fluid supply line, and a leak in the cooling circuit.

In one embodiment, the transformer 10 further includes a rectifier 50, forming a direct current power supply that converts alternating current to direct current. Additionally, as should be easily understood by those skilled in the art, the transformer 10 may be in the form of a medium frequency direct current type transformer or other conventional type of transformers.

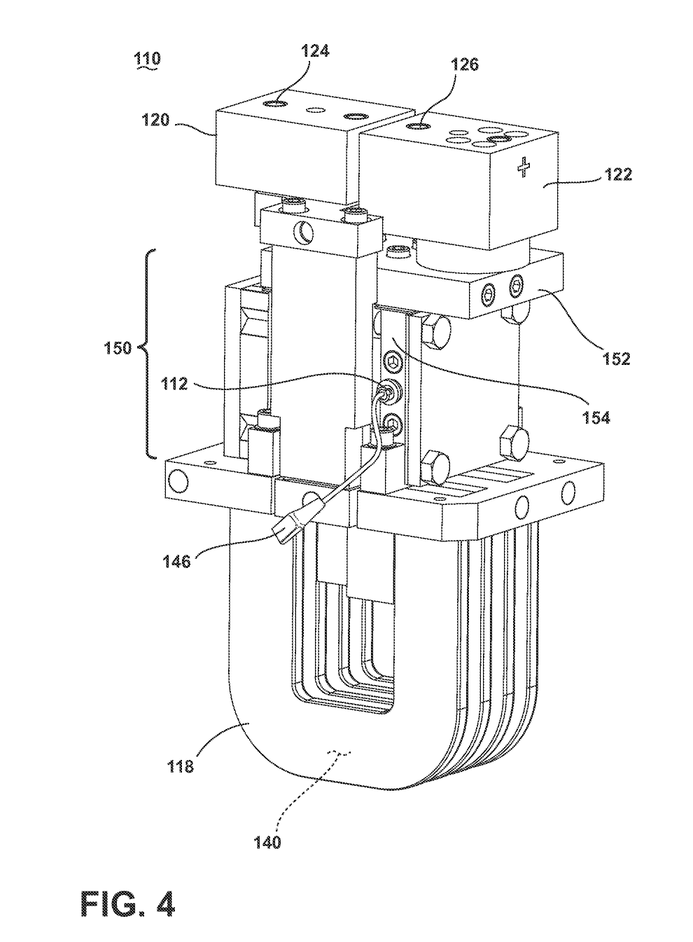

Referring to FIG. 4, the number 110 designates another exemplary embodiment of a transformer. This more complex transformer 110 includes multiple secondary windings 118, core 114, a rectifier 150, a DC collector bus 152, and multiple chill blocks 154. The DC collector bus 152 and chill blocks 154 have fluid passages internally formed therein, as is conventional. The cooling circuit 140 is defined by the secondary windings 118, negative and positive output terminals 120 and 122, and additionally by the DC collector bus 152 and chill blocks 154. Although not shown, hoses may also be included in the cooling circuit 40 to connect components that are not directly fluidly or physically adjoined. It should be readily understood by those skilled in the art that additional blocks and other conventional transformer components may also be included in the transformer and may form part of the cooling circuit.

The flow meter 112 may be located in a variety of positions within the transformer 110, provided that the selected position allows the flow meter 112 to be operatively coupled with the cooling circuit 140. In the illustrated example, the flow meter 112 is shown mounted to chill block 154; however, mounting the flow meter 112 to any one of the DC collector bus 152, chill blocks 154, or in any component of the cooling circuit 140 is also feasible.

Transformers are often used to power resistance welding equipment, and resistance welding is the predominant means for joining sheet metal of an automobile body. Depending on the particular application, resistance welding equipment may include a robot and robotic arm, a weld controller, a welding gun, actuators, check fixtures, etc. Further, the equipment may also perform other functions, including fixturing, part placement and movement, inspection, gaging, etc. Because resistance welding equipment performs such a variety of functions and requires such a large quantity of components, the equipment has characteristically been very compact with a dense placement of components. Accordingly, space is a premium and any size reduction of the components is beneficial.

Integrating the flow sensor directly into the transformer is advantageous for multiple reasons: a reduction in weight, cost, and assembly/manufacture time, as well as an improvement in reliability. First, the total weight of the transformer and sensor is reduced by eliminating the housing, external mounting brackets, external hoses, and fittings that the prior art sensor requires. It is estimated that there is an overall weight reduction of one to two pounds from integrating the sensor into the transformer. This is beneficial in all applications, but particularly beneficial in resistance welding transguns due to the weight and physical space challenges faced in resistance welding machine and welding gun design. The majority of transguns are mounted on the ends of robot arms which have specific weight and physical requirements. Due to the limited weight, size, physical, and ergonomic requirements, many of the current robot and manual transgun applications cannot have a remote flow sensor mounted on them. This integrated solution solves that problem. Second, integrating the sensor into the transformer reduces the time and labor required for installation; instead of installing a transformer and an external sensor separately, an integrated transformer and sensor assembly can be installed as one item. Third, without the housing, external mounting brackets, external hoses, and fittings required by the prior art sensor, there is a piece-price cost saving of the sensor. There is also a cost saving associated with the reduction in labor for installation of the sensor, as well as in ongoing maintenance. Lastly, incorporating the sensor directly into the transformer increases the reliability of the transformer, which leads to improved overall welding system reliability. The present transformer is substantially lighter and less complex than previously known water-cooled transformers. These and other benefits should be readily appreciated by one having skill in the art.

It should be understood that while the transformer is described above for use in resistance welding, the transformer could be used in any number of other applications that utilize water-cooled transformers. For example, the present transformer could be used in manufacturing equipment used in the production of glass; including melting, boosting, refining, and forming of glass. Other examples of industrial applications where the transformer could be utilized include furnaces, electroplating, and resistance heating applications such as heat treating, hardening, annealing, and upsetting.

The above descriptions are those of the current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A fluid-cooled transformer comprising:
a transformer including a primary winding, a secondary winding, and a core;
a fluid flow path through at least one of the primary and the secondary windings; and
a flow sensor operatively coupled to the fluid flow path and protectively positioned within the transformer.

2. The fluid-cooled transformer of claim 1, including two terminals, a fluid inlet, and a fluid outlet which form a portion of the fluid flow path.

3. The fluid-cooled transformer of claim 2, wherein the fluid flow path is configured to carry fluid for cooling the transformer.

4. The fluid-cooled transformer of claim 3, wherein the flow sensor is mounted to the fluid flow path such that the flow sensor is in fluid communication with fluid passing through the fluid flow path.

5. The fluid-cooled transformer of claim 4, wherein both the flow sensor and the transformer are in electrical communication with a controller.

6. The fluid-cooled transformer of claim 5, wherein the flow sensor is adapted to provide an indication to the controller when fluid flow within the fluid flow path is at a rate less than a predetermined rate, the controller causing the transformer to cease operating in response to the indication from the flow sensor.

7. The fluid-cooled transformer of claim 6, wherein the flow sensor is a vortex shedding type flow meter.

8. The fluid-cooled transformer of claim 1, including a rectifier.

9. A fluid-cooled transformer comprising:
a core;
a primary winding;
a secondary winding having two terminals and defining a cooling circuit having a fluid inlet and a fluid outlet, the cooling circuit configured to carry fluid for cooling the transformer; and
a fluid flow meter for detecting a flow of fluid circulated within the cooling circuit, the fluid flow meter located within the transformer.

10. The fluid-cooled transformer of claim 9, wherein one of the two terminals includes a mounting hole adapted to mount the fluid flow meter such that the fluid flow meter is in fluid communication with fluid within the cooling circuit.

11. The fluid-cooled transformer of claim 10, wherein the fluid flow meter includes an electrical connection and both the transformer and the fluid flow meter are in electrical communication with a controller.

12. The fluid-cooled transformer of claim 11, wherein the fluid flow meter is adapted to provide an indication to the controller when fluid flow is at a rate less than a predetermined fluid flow rate, the controller causing the transformer to cease operating in response to the indication from the fluid flow meter.

13. The fluid-cooled transformer of claim 10, including a plurality of spaced secondary windings and one or more connector blocks configured to fluidly connect the secondary windings.

14. The fluid-cooled transformer of claim 10, wherein the fluid flow meter is a vortex shedding type flow meter.

15. The fluid-cooled transformer of claim 10, including a rectifier.

16. A fluid-cooled transformer comprising:
a core;
a primary winding;
a plurality of spaced secondary windings having a fluid inlet and a fluid outlet;
a negative output terminal and a positive output terminal;
a rectifier;
a collector bus and a plurality of connecting blocks;
a cooling circuit, the cooling circuit configured to carry fluid for cooling the transformer and rectifier; and
a fluid flow meter for detecting a flow of fluid circulated within the cooling circuit, the fluid flow meter located in the cooling circuit.

17. The fluid-cooled transformer of claim 16, wherein one of the terminals, secondary windings, collector bus and connecting blocks includes a mounting hole adapted to mount the fluid flow meter such that the fluid flow meter is in fluid communication with fluid in the cooling circuit.

18. The fluid-cooled transformer of claim 17, wherein the fluid flow meter includes an electrical connection and the transformer and the fluid flow meter are in electrical communication with a controller.

19. The fluid-cooled transformer of claim 18, wherein the fluid flow meter is adapted to provide an indication to the controller when fluid flow is at a rate less than a predetermined fluid flow rate, the controller causing the transformer to cease operation in response to the indication from the fluid flow meter.

20. The fluid-cooled transformer of claim 19, wherein the fluid flow meter is a vortex shedding type flow meter.
